(19) United States
(12) Patent Application Publication
(10) Pub. No.: US 2022/0284319 A1
(43) Pub. Date: Sep. 8, 2022

(54) INTELLIGENT GUIDANCE USING MACHINE LEARNING FOR USER NAVIGATION OF MULTIPLE WEB PAGES

(71) Applicant: International Business Machines Corporation, Armonk, NY (US)

(72) Inventors: Dong Chen, Beijing (CN); Peng Fei Tian, Beijing (CN); Ting Ting Zhan, Beijing (CN); Jing Bai, Beijing (CN); Xiaoli Duan, Beijing (CN)

(21) Appl. No.: 17/190,383

(22) Filed: Mar. 2, 2021

(51) Int. Cl. G06N 5/04; G06F 16/954; G06N 20/00

(52) U.S. Cl. CPC G06N 5/04; G06F 16/954; G06N 20/00

(57) ABSTRACT

Facilitating web page selection by a user navigating multiple web pages on a computer can include determining, using a computer, a probability of each of a plurality of web pages being visited by a user. The probability can be determined using machine learning and user operational behavior analysis based on an analysis of web page features. Using a cognitive analysis, the open web pages can be ordered based on the probability of each of the web pages being visited by the user. The ordering can include ranking web pages based on a highest probability of a web page being visited. The open web pages can be managed based on the ordering of the open web pages where the managing includes prompting the user to visit a web page of the open web pages in response to the ranking of an open web page in the order.

### BACKGROUND

The present disclosure relates to analyzing, using a computer, data including page content of web pages to determine a likelihood of a user page selection and to facilitate the page selection by the user, wherein the user is navigating multiple web pages using a device or computer.

Web browsers used via a device, mobile device, or a computer can connect to the Internet to enable a user to access websites having web pages. Such websites and web pages can include information, services, commercial sales, wherein such commercial sales can include retail items, and stores having virtual sales. Additionally, websites and web pages can include social platforms, and virtual meetings, etc.

In one example, web browsers are used as a platform for a user to do work (for example, including, development, or testing), browse daily news, and view entertainment information. For example, a user may have many web pages open making it likely for a user to lose pages or difficult to find an open page. Thereby, it may be difficult for a user to quickly navigate to a desired open page or return to a desired open page.

Such situations with a plurality of open web pages can result in frustration for the user in navigating open web pages and result in lost time, effort, and inefficiencies related to web page navigation.

### SUMMARY

The present disclosure recognizes the shortcomings and problems associated with current techniques for web page selection when a user has multiple web pages open on a device.

An embodiment according to the present invention can include extracting page features to determine pages which a user will most probably visit, by means of machine learning and user operation behavior analysis. One embodiment according to the invention can include performing quantitative manipulation of the possibility that each page will be visited, and then undertaking page management based on the quantitative analysis result. The embodiment can include performing unified management of the pages, and providing relative hints and tips for the pages with high possibility of being visited during the selection process, and performing unified management of the pages, including hiding or closing pages with low visit frequency.

In an aspect according to the present invention, a computer-implemented method for facilitating web page selection for a user navigating multiple web pages includes determining, using a computer, a probability of each of a plurality of web pages being visited by a user. The web pages are opened by the user using a device. The probability is determined using machine learning and user operational behavior analysis based on an analysis of the web page features for each of the web pages being visited by the user. The method includes filtering the web pages by classifying the web page features. The method includes ordering, using a cognitive analysis, the open web pages in an order based on the probability of each of the web pages being visited by the user. The order ranking the plurality of web pages based on a highest probability of a web page of the plurality of web pages being visited. The method including managing the open web pages based on the ordering of the open web pages, the managing including prompting the user to visit a web page of the open web pages in response to the ranking of an open web page in the order.

In a related aspect, the method can include analyzing, using a computer, web page features of respective web pages opened by a user using a device; filtering the web pages by classifying the web page features using a matrix of classification for each of the features; and generating a filtered web page collection based on the classifying of the web page features.

In a related aspect, the managing includes prompting the user to visit a web page of the open web pages having the highest probability of being visited by the user.

In a related aspect, the page features can include multiple attributes relating to each of the open web pages.

In a related aspect, the page features can include multiple attributes relating to each of the open web pages; and analyzing the page features wherein the analyzing includes classifying the features and attributes into patterns.

In a related aspect, the page features can include multiple attributes relating to each of the open web pages; and analyzing the page features wherein the analyzing includes classifying the features and attributes into patterns, wherein the patterns include a continuation regular pattern and a non-continuation pattern.

In a related aspect, the page features include opening time of the page and a source of the page.

In a related aspect, wherein as part of the determining of the probability of each of the web pages being visited by the user, the determining includes logic for switching pages; and training a learning module to learn the logic.

In a related aspect, the method further includes: determining a page jump operation using the cognitive analysis, the cognitive analysis includes quantitative analysis of a visit possibility for the filtered page collection; and providing page jump information for the managing of the open web pages.

In another aspect according to the invention, a system using a computer for facilitating web page selection for a user navigating multiple web pages includes a computer system comprising; a computer processor, a computer-readable storage medium, and program instructions stored on the computer-readable storage medium being executable by the processor, to cause the computer system to perform the following functions to; determine, using a computer, a probability of each of a plurality of web pages being visited by a user, the web pages being opened by the user using a device, the probability being determined using machine learning and user operational behavior analysis based on an analysis of the web page features for each of the web pages being visited by the user and filtering the web pages by classifying the web page features; order, using a cognitive analysis, the open web pages in an order based on the probability of each of the web pages being visited by the user, the order ranking the plurality of web pages based on a highest probability of a web page of the plurality of web pages being visited; and manage the open web pages based on the ordering of the open web pages, the managing including prompting the user to visit a web page of the open web pages in response to the ranking of an open web page in the order.

In a related aspect, the method further includes analyzing, using a computer, web page features of respective web pages opened by a user using a device; filtering the web pages by classifying the web page features using a matrix of classification for each of the features; generating a filtered web page collection based on the classifying of the web page features.

In a related aspect, the managing includes prompting the user to visit a web page of the open web pages having the highest probability of being visited by the user.

In a related aspect, the page features can include multiple attributes relating to each of the open web pages.

In a related aspect, the page features can include multiple attributes relating to each of the open web pages; and analyzing the page features wherein the analyzing includes classifying the features and attributes into patterns.

In a related aspect, the page features include multiple attributes relating to each of the open web pages; and analyzing the page features wherein the analyzing includes classifying the features and attributes into patterns, wherein the patterns include a continuation regular pattern and a non-continuation pattern.

In a related aspect, the page features include opening time of the page and a source of the page.

In a related aspect, wherein as part of the determining of the probability of each of the web pages being visited by the user, the determining includes logic for switching pages; and training a learning module to learn the logic.

In a related aspect, the system further includes: determining a page jump operation using the cognitive analysis, the cognitive analysis includes quantitative analysis of a visit possibility for the filtered page collection; and providing page jump information for the managing of the open web pages.

In another aspect according to the present invention, a computer program product for facilitating web page selection for a user navigating multiple web pages. The computer program product comprising a computer readable storage medium having program instructions embodied therewith, the program instructions executable by a computer to cause the computer to perform functions, by the computer, comprising the functions to: determine, using a computer, a probability of each of a plurality of web pages being visited by a user, the web pages being opened by the user using a device, the probability being determined using machine learning and user operational behavior analysis based on an analysis of the web page features for each of the web pages being visited by the user and filtering the web pages by classifying the web page features; order, using a cognitive analysis, the open web pages in an order based on the probability of each of the web pages being visited by the user, the order ranking the plurality of web pages based on a highest probability of a web page of the plurality of web pages being visited; and manage the open web pages based on the ordering of the open web pages, the managing including prompting the user to visit a web page of the open web pages in response to the ranking of an open web page in the order.

In a related aspect, the computer program product can further include: analyzing, using a computer, web page features of respective web pages opened by a user using a device; filtering the web pages by classifying the web page features using a matrix of classification for each of the features; generating a filtered web page collection based on the classifying of the web page features.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system, system features or components, and methodology for facilitating web page selection by a user navigating multiple web pages, according to an embodiment of the present disclosure.

FIG. 2 is a flow chart illustrating a method, implemented using the system shown in FIG. 1, for facilitating web page selection by a user navigating multiple web pages, according to an embodiment of the present disclosure.

FIG. 3 is a functional schematic block diagram showing a series of operations and functional methodologies, for instructional purposes illustrating functional features of the present disclosure associated with the embodiments shown in the FIGS., for facilitating web page selection by a user navigating multiple web pages.

FIG. 4A is a flow chart illustrating another method, continuing from the method shown in FIG. 2, which can be implemented, at least in part, using the system shown in FIG. 1, for facilitating web page selection by a user navigating multiple web pages, according to an embodiment of the present disclosure.

FIG. 4B is a flow chart illustrating another method, continuing from the method shown in FIG. 1, which can be implemented, at least in part, using the system shown in FIG. 1, for facilitating web page selection by a user navigating multiple web pages, according to an embodiment of the present disclosure.

FIG. 5 is a flow chart illustrating an example method including functional operations according to the present disclosure, directed to analyzing open web pages.

FIG. 5A is a flow chart, continuing from the flow chart shown in FIG. 5, illustrating an example method including functional operations according to the present disclosure, directed to analyzing open web pages and cursor movement.

FIG. 6 is a flow chart, illustrating an example method including functional operations according to the present disclosure, directed to analyzing open web pages for pattern and trends.

FIG. 7 is a flow chart, illustrating an example method including functional operations according to the present disclosure, directed to analyzing open web pages patterns and user behavior.

FIG. 8 is a flow chart, illustrating an example method including functional operations according to the present disclosure, directed to analyzing open web pages and classifying the open web pages.

FIG. 9 is a block diagram, illustrating an example method and system including functional operations according to the present disclosure, directed to analyzing open web pages for modeling patterns of usage.

FIG. 10 is a schematic block diagram depicting a computer system according to an embodiment of the disclosure which may be incorporated, all or in part, in one or more computers or devices shown in FIG. 1, and cooperates with the systems and methods shown in the FIGS.

FIG. 11 is a block diagram depicting a cloud computing environment according to an embodiment of the present invention.

FIG. 12 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

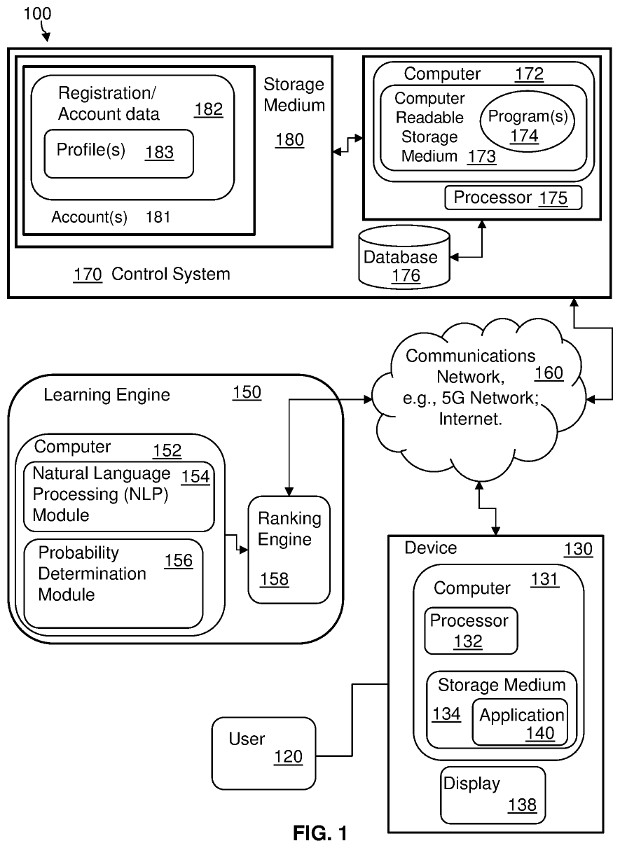

Referring to FIGS. 1, 2 and 3, a computer-implemented method 200 for facilitating web page selection by a user navigating multiple web pages, according to an embodiment of the present disclosure. The method 200 includes a-series of operational blocks for implementing an embodiment according to the present disclosure. The method 200 includes receiving at a learning engine 150 web page data 308 regarding a plurality of web pages 304 opened by a user 120 using a device 130, as in block 204. The web page data can include, for example, the web page source and length of time open.

The method 200 includes analyzing the web page data, as in block 208, for web page features and information regarding the web pages, such as the web page source and length of time open.

The method 200 include filtering the web pages by classifying the web page features based on the analysis of the web pages, as in block 212.

The method includes receiving, at the learning engine 150, operation behavior data 312 about user behavior regarding the opening of webpages, as in block 216. Such operation data can include, for example, website usage, time on a website, frequency of usage or visiting of a website, etc. The learning engine 150 can include a computer 152. The learning engine and computer can include a natural language processing module (NLP) 154. The NLP module 154 can be used to process web site text information. The learning engine 150 can include a probability determination module 156. The probability determination module 156 can be used to calculate a probability of a user visiting one of a plurality of open websites. A ranking engine 158 can rank the open website based on the probability of a user visiting a website. For example, a website with a highest probability of being visited by a user can be raked the highest.

Analyzing, using the learning engine, the operation behavior data for patterns of usage by the user, as in block 220. Such patterns can include, for example, identifying websites which are opened corresponding to a time or day, or on specific days, as well as frequency of opening and time visited. Further examples can include, identifying websites which correspond to a user being present at a location, or a vacation time of a user, or during working hours. Thereby, the learning engine can generate.

In one example, the method includes building a machine learning model based on the user operational behavior analysis, as in block 224.

The method includes determining a probability of each of the plurality of web pages being visited by the user, as in block 228, based on the operation behavior data and the web page data. The determining of the probability includes analyzing the machine learning model, and using the analysis of the web page features for each of the web pages being visited by the user.

The method includes ordering, using a cognitive analysis 316, the open web pages in an order 324 based on the probability of each of the web pages being visited by the user, as in block 232. The order ranking 328 the plurality of web pages based on a highest probability of a web page of the plurality of web pages being visited.

The method includes managing the open web pages 332 based on the ordering of the open web pages, as in block 236. The managing including prompting 336 the user to visit a web page of the open web pages in response to the ranking of an open web page in the order, as in block 240.

### Additional Embodiments and Examples

In another embodiment according to the present disclosure, the method can further include generating a filtered web page collection based on the classifying of the web page features.

In another example, the managing of the open web pages based on the ordering of the open web pages can include prompting the user to visit a web page of the open web pages having the highest probability of being visited by the user.

In another embodiment and example according to the present disclosure, the page features can include multiple attributes relating to each of the open web pages. The multiple attributes can include, for example, page content, page source, and page metadata. The method can include analyzing the page features wherein the analyzing includes classifying the features and attributes into patterns, wherein the patterns include a continuation regular pattern and a non-continuation pattern classifying continuation pattern and no continuation pattern.

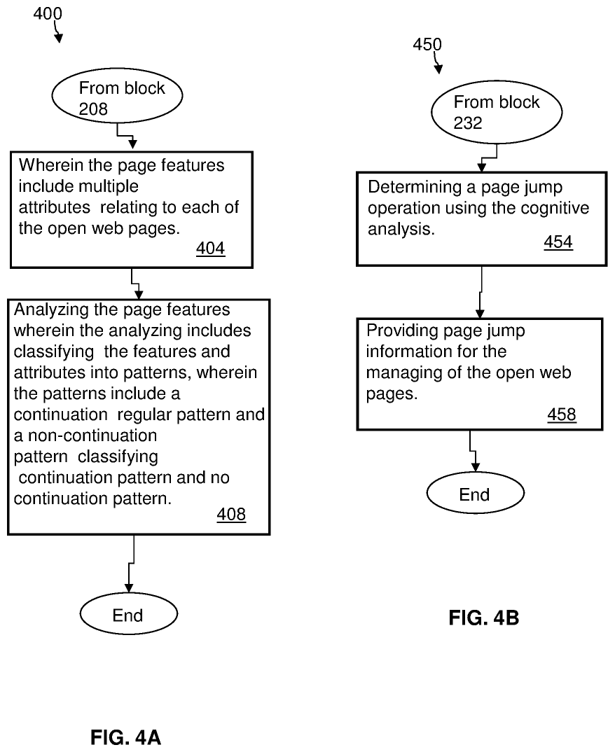

Referring to FIG. 4A, a method 400 continues from block 208 of method 100, in another embodiment and example according to the present disclosure, includes the page features including multiple attributes relating to each of the open web pages, as in block 404. The method 400 includes analyzing the page features wherein the analyzing includes classifying the features and attributes into patterns, wherein the patterns include a continuation regular pattern and a non-continuation pattern, as in block 408.

In another example, the page features can include an opening time of a page and a source of the page.

In another example, as part of the determining of the probability of each of the web pages being visited by the user, includes logic for switching pages, and training a learning module to learn the logic.

Referring to FIG. 4B, in another embodiment according to the present disclosure, a method 450 continues from block 232 of the method 100, includes determining a page jump operation using the cognitive analysis, as in block 454. The cognitive analysis includes quantitative analysis of a visit possibility for the filtered page collection. The method 450 includes providing page jump information for the managing of the open web pages.

### Other Embodiments and Examples

Referring to FIG. 1, the user device 130 includes a computer 131 having a processor 132 and a storage medium 134 where an application 140, can be stored. The application can embody the features of the method of the present disclosure as instructions. The user can connect to a learning engine 150 using the device 130. The device 130 which includes the computer 131 and a display or monitor 138. The application 40 can embody the method of the present disclosure and can be stored on the computer readable storage medium 134. The device 130 can further include the processor 132 for executing the application/software 140. The device 130 can communicate with a communications network 160, e.g., the Internet.

It is understood that the user device 30 is representative of similar devices which can be for other user, as representative of such devices, which can include, mobile devices, smart devices, laptop computers etc.

In another example and embodiment, profiles can be saved for users/participants. Such profiles can supply data regarding the user and history of deliveries for analysis. When a profile is not found at block 112, the method creates a profile at block 116.

In one example, the system of the present disclosure can include a control system 170 communicating with the user device 130 via a communications network 160. The control system can incorporate all or part of an application or software for implementing the method of the present disclosure. The control system can include a computer readable storage medium 173 where account data and/or registration data 182 can be stored. User profiles 183 can be part of the account data and stored on the storage medium 180. The control system can include a computer 172 having computer readable storage medium 173 and software programs 174 stored therein. A processor 175 can be used to execute or implement the instructions of the software program. The control system can also include a database 176.

In one example, a user can register or create an account using the control system 170 which can include one or more profiles 183 as part of registration and/or account data 182. The registration can include profiles for each user having personalized data. For example, users can register using a website via their computer and GUI (Graphical User Interface) interface. The registration or account data 182 can include profiles 183 for an account 81 for each user. Such accounts can be stored on the control system 170, which can also use the database 176 for data storage.

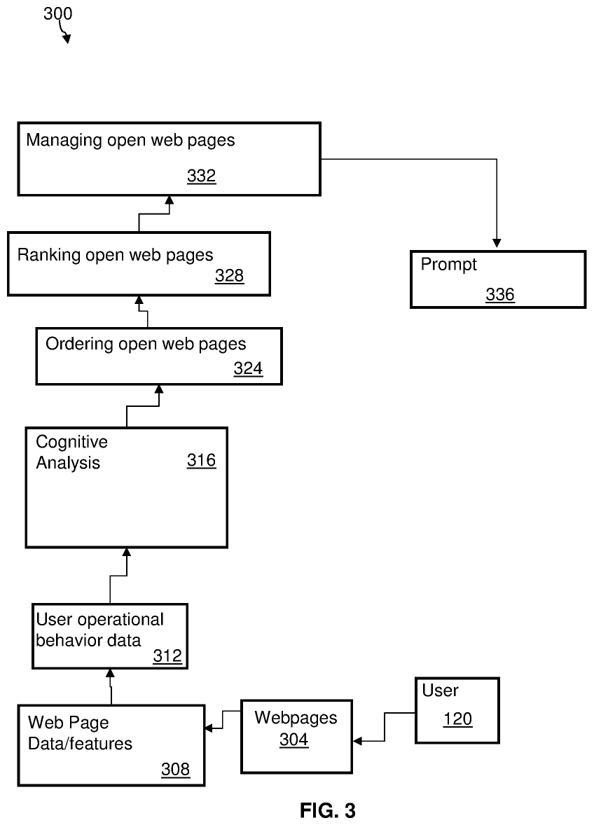

Additionally, the method and system is discussed with reference to FIG. 3, which is a functional system 300 which includes components and operations for embodiments according to the present disclosure, and is used herein for reference when describing the methods and systems of the present disclosure. Additionally, the functional system 300, according to an embodiment of the present disclosure, depicts functional operation indicative of the embodiments discussed herein.

### More Embodiments and Examples

Embodiments of the present disclosure can include a system and method for analyzing user patterns of web page usage, for instance, web page opening repetition, with consent and approval of the user. Additionally, the system and method can include page content recognition in addition to analyzing user patterns to generate machine learning to determine a most likely page that a user may go to, that is, open next. The system and method can give tips or prompts so that a user can find and click, using a mouse or other means of selection, on a web page to which they want to navigate or select from a plurality of pages.

In one example a method and system can extract page features, get a collection of pages which users will most probably visit by means of machine learning and user operation behavior analysis, perform quantitative manipulation of the possibility that each page will be visited, and then undertake pages management based on the quantitative analysis result. The method and system can include performing unified management of the pages, and providing relative hints and tips for the pages with high possibility during the selection process. Further, the method and system can perform unified management of the pages, hide or close the pages with low visit frequency.

Embodiments according to the present disclosure can provide a set of effective page features for page jump operation analysis. The analysis can include a user page jump intention based on information such as pattern status, current page content and so on. Possible collection of pages based on user page jump intention can be filtered. A quantitative intention can be proposed to perform quantitative analysis of a visit possibility for the filtered page collection, and page jump help information to users can be provided, which includes, but is not limited to, text, graphics, colors or a combination of these.

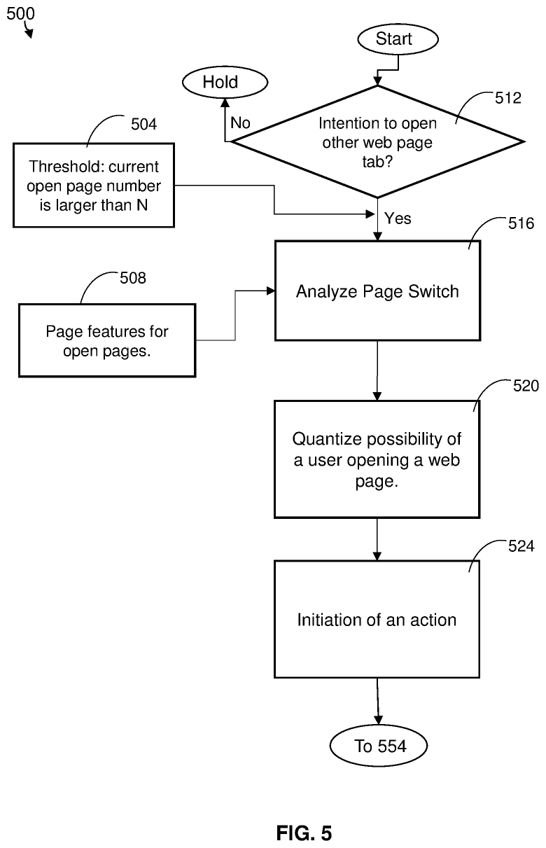

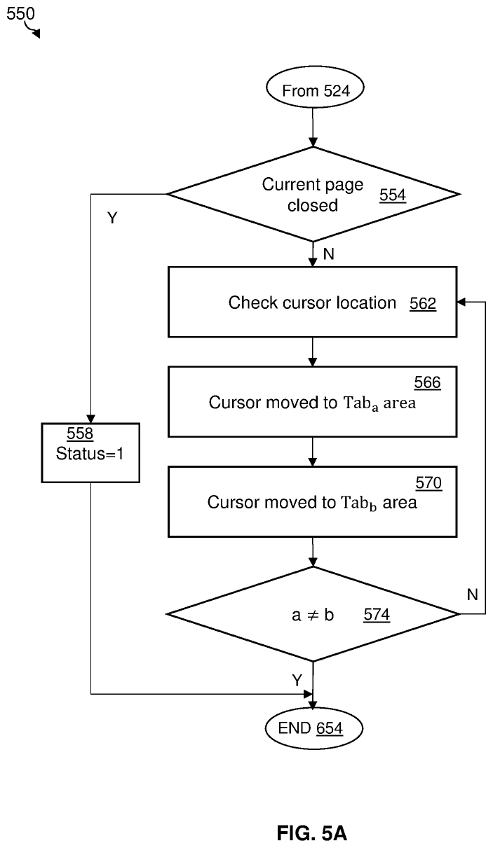

Referring to FIG. 5, one embodiment of a system 500 and method according to the present disclosure includes determining when a current number of open web pages exceeds a threshold, for example, larger than N, after setting a threshold for a number of open web pages. An example threshold is shown in block 504. The system 500 includes extracting current page features for open web pages. In one example, the features can be categorized or classified. An example of current page features for open pages in shown in block 508. The system 500 includes determining when a user intends to open another web page tab, as in block 512, or determining a probability for when a use intends to open another web page tab. Such probability of intention can be determined based on analyzing using patterns and history.

Again referring to FIG. 5, the system 500, when determining that a user intends to open another web page 512, can proceed to analyze the page switch 516 based on the page features 508 and ascertaining that the threshold 504 is met. The system 500 determines a probability of a user opening each web page or tab or page collection as in block 520, which includes quantizing a possibility of a user opening one or more web pages. In response to the possibility of a user opening a web page, the system can initiate an action, as in block 524.

Thereby, referring to FIG. 5, the system 500 ascertains a probability of when a user is going to switch pages by extracting and analyzing user behavior features. Further, the system can understand the purpose or reason for a user to switch pages, by extracting current page features. The system can accurately quantize the possibility of a user to jump or change or select another or other opened pages.

Referring to FIG. 5A, a method 550 continuing from the system action in block 524 of the system 500 includes determining when a current page, with a high probability of being selected or jumped to by the user, is closed, as block 554. When the web page with high probability or meeting a threshold of probability for being selected is determined, the method continues to set a status of ‘1’ at block 558 and then to end 654. When the web page with a high probability or meeting a threshold of probability for being selected is determined, the method 550 proceeds to check a cursor location as in block 562. The system and method include anticipating or determining when a user will use a web page using the above method such as determining when the page is open or closed. The method may automatically move between two or more active pages. The pages can be layered one on top of the other viewable on a display.

The method 550 includes moving a cursor to a Tabₐ area, at block 566, in response to determining a user probability of changing to a Tabₐ meets a probability threshold. In another example, the method includes moving a cursor to Tab_{b} area, as in block 570, in response to determining when a user probability of changing to Tab_{b} meets a probability threshold.

The method 550 includes determining when a=b, that is when an ‘a’ tab and a ‘b’ tab are equal to each other, or the same tab. When ‘a’ does not equal ‘b’ than the method returns to block 562 to check for cursor locations. When ‘a’ does equal ‘b’ the method ends 654.

Regarding, for the system and method, determining probabilities of switching pages by the users, a machine learning model can be built to for the application to understand the specific logic of the user switching the pages. Then, the machine learning model can be trained to deploy the models to learn the logic, which is based on the extraction of page features and the acquisition of feature values. The learning ability is used as the basis for quantifying the possibility that users will open a tab page. The training data can be gathered from a user's real-time operation on the page. Data features can be used to analyze the purpose of switching the page by the user. The data features can include: The status before moving to a module state; user's cursor position in a current page; user's action flow before switching pages; effective reading level of users on each opened page; page layout structure of a current page; keywords, topics and categories of current page content; and relationship of a current page and opened pages. User behavior can be attached to association between pages, for example, mainly reflected in the regular and irregular feature.

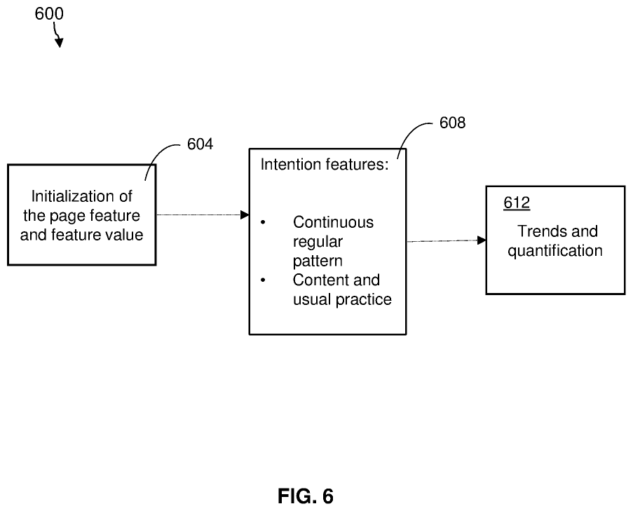

Referring to FIG. 6, a method 600 includes initialization of a page feature and feature value, as in block 604. When completing an operation of switching from one page to another, the method can be divided into continuation regular pattern and non-continuation pattern, as shown in block 608. Two aspects for consideration in the non-continuous regular pattern can include content and usual practice, as shown in block 608. The pattern shown in block 608 can be used to determine trends and quantifications, as in block 612.

Definitions can include a page ID and opening time which can include routine assistance. Page identification can be used when doing the regular pattern analysis. Page source can be used in user behavior analysis. A page status can include be combining with page source for used to analyze the regular pattern of the status of a single page. A content of topic can be used when doing a content analysis. A page layout can be used in a content analysis. Reading times can be combined with a page identification, considering a regular pattern analysis on the page group. Effective reading can include auxiliary content and regular pattern analysis.

According to current page content, combined with user habits, a subset of pages can be filtered, and the probability that each page in the subset may be jumped is quantified. Each page can be jumped with respect to user initiation, so that with the use of a browser help information can be presented (for example, using text, color, graphics, etc.) to a user in an intuitive way.

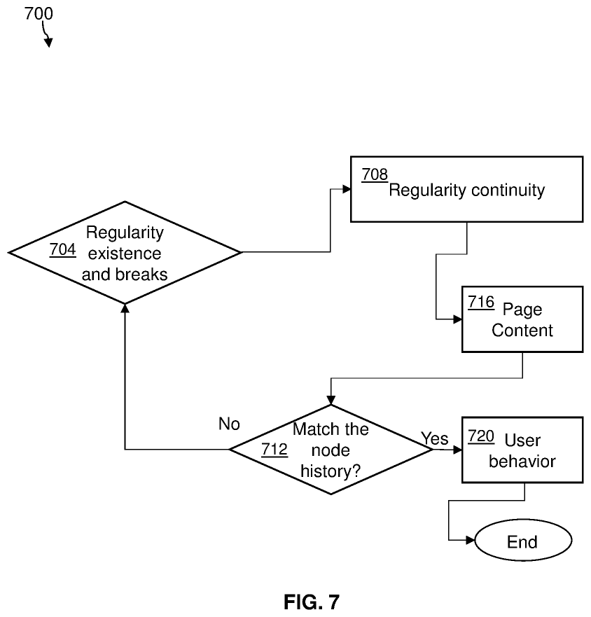

Referring to FIG. 7, a method 700 includes selecting a web page based on a probability of selection by a user by determining regularity of existence and breaks, as in block 704. In one example, for a feature and feature value, a regularity maintenance module can be referred to. Irregular performance and features of page selection resistance can refer to resistance in the selection of page content, and a user needing to jump to pages with specific content. In this situation, selection of a page by a user can be related to the current page content, as well as the user's usual behavior and thinking methodology, that is, personalized aspects for the user.

An analysis on the page identity and read times, as in block 708, the method can effectively find page reading rules, and then provide help for page switching.

A page switch can come from the content association between pages, the content source, content topic, whether the content is effectively read, and the page layout, as in block 716.

User usual behavior, as in block 720, can be used to analyze the possibility of users going to each node based on the current node. This depends on the attributes and history of the nodes before and after the switch, as in block 712. For example, a node list can be kept and node relationships can be categorized.

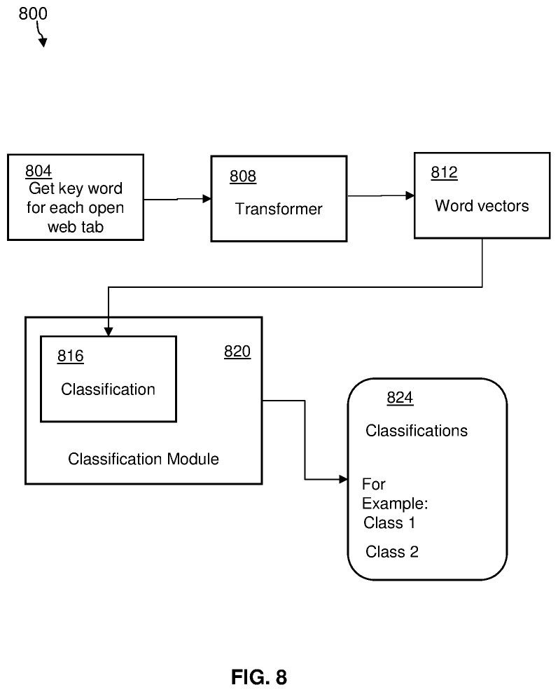

Referring to FIG. 8, referring to node relationships and categorization, a method 800 can include determining a key word for each open web tab, as in block 804. Using a transformer 808 word vectors 812 can be generated. Classification 816 can be generated using a classification module 820 to generate classifications 824. In one example, open web tabs can be classified and the tabs which belong to the same class can be in the same queue. For each queue, there can be a mark which shows if a tab has been read or unread. When a user jumps web tabs and goes back from one class to a new tab which is in a different class, the classification module can recommend the tab that a user may go to. A recommendation can be from the unread tabs from a previous class (based on the distance from the word vector of a tab to the center of the previous class).

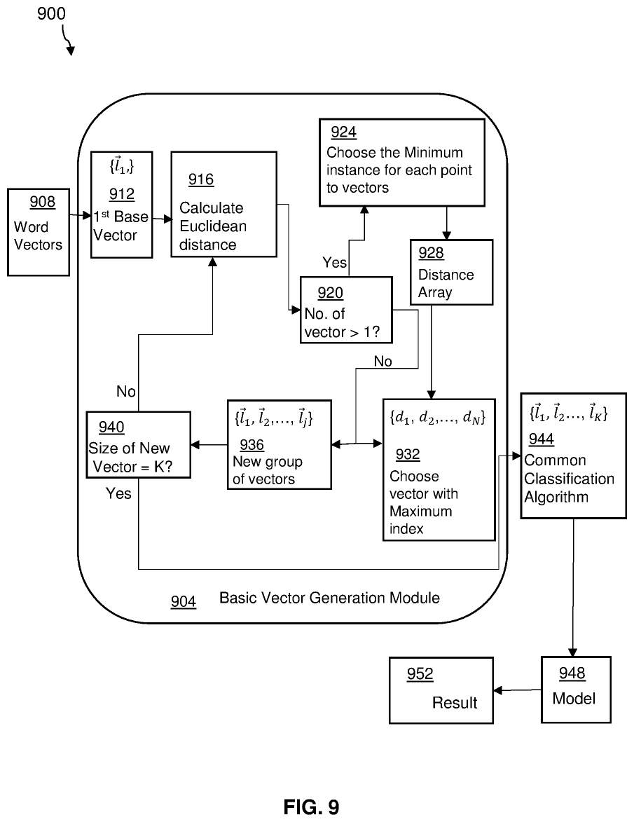

Referring to FIG. 9, a system 900 according to an embodiment of the disclosure, for generating a vector includes inputting word vectors 908 into a basic vector generation module 904 to receive a first base vector 912. First base vector can be represented as 1₁ The system basic vector generation module 904 can calculate a Euclidean distance 916. When a number of vectors is greater than 1 at block 920, the system proceeds to choose the minimum instance for each point to vectors, as in block 924. The system proceeds to a distance array at block 928, and then to choose a vector with a maximum index at block 932, represented by {d₁, d₂, . . . , d_{N}}.

When a number of vectors is less than 1 at block 920, the system proceeds to choose a maximum one's index at block 932, or proceeds to a new group of vector, at block 936, represented by {l₁, l₂ . . . , lₖ}. From the new group of vectors at block 936, the system proceeds to determine a size of a new vector which equals a given, represented by K, at block 940. When the vector equals K, the system proceeds to a common classification algorithm at block 944, represented by {l1, l2 . . . , lk}. The system proceeds to generate a model at block 948 and outputs a result at block 952.

When the new vector does not equal K at block 940, the system returns to block 916.

### More Examples and Embodiments

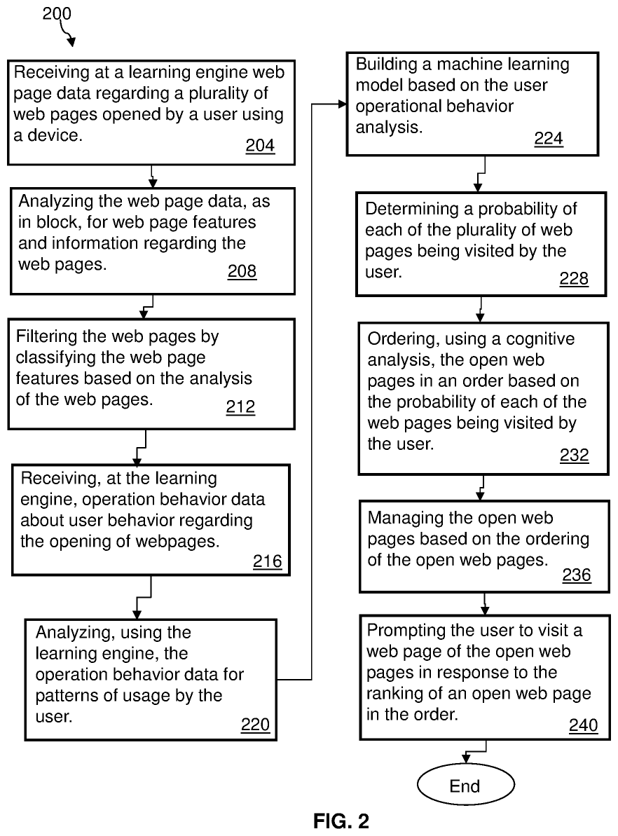

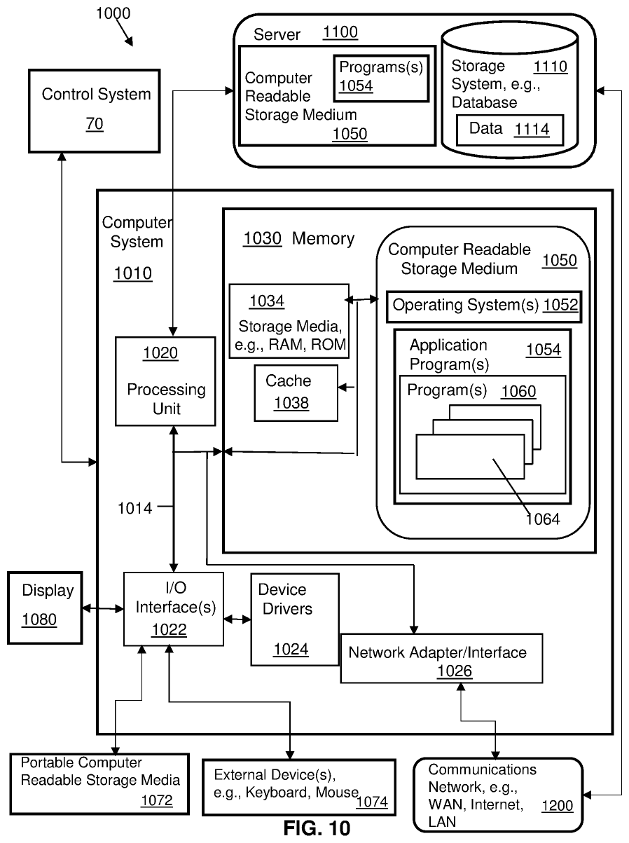

In the embodiment of the present disclosure shown in FIGS. 1 and 2, a computer can be part of a remote computer or a remote server, for example, remote server 1100 (FIG. 10). In another example, the computer 131 can be part of a control system 170 and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device 130 can include a computer 131 having a processor 132 and a storage medium 134 which stores an application 140, and the computer includes a display 138. The application can incorporate program instructions for executing the features of the present disclosure using the processor 132. In another example, the mobile device application or computer software can have program instructions executable for a front end of a software application incorporating the features of the method of the present disclosure in program instructions, while a back end program or programs 174, of the software application, stored on the computer 172 of the control system 170 communicates with the mobile device computer and executes other features of the method. The control system 170 and the device (e.g., mobile device or computer) 130 can communicate using a communications network 160, for example, the Internet.

Thereby, the method 100 according to an embodiment of the present disclosure, can be incorporated in one or more computer programs or an application 140 stored on an electronic storage medium 134, and executable by the processor 132, as part of the computer on mobile device. For example, a mobile device can communicate with the control system 170, and in another example, a device such as a video feed device can communicate directly with the control system 170. Other users (not shown) may have similar mobile devices which communicate with the control system similarly. The application can be stored, all or in part, on a computer or a computer in a mobile device and at a control system communicating with the mobile device, for example, using the communications network 160, such as the Internet. It is envisioned that the application can access all or part of program instructions to implement the method of the present disclosure. The program or application can communicate with a remote computer system via a communications network 160 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 10 and described in more detail in regards thereto referring to one or more computer systems 1010.

Thus, in one example, a control system 170 is in communication with the computer 130, and the computer can include the application or software 140. The computer 130, or a computer in a mobile device (not shown) communicates with the control system 170 using the communications network 160.

In another example, the control system 170 can have a front-end computer belonging to one or more users, and a back-end computer embodied as the control system.

Also, referring to FIG. 1, a device 130 can include a computer 131, computer readable storage medium 134, and operating systems, and/or programs, and/or a software application 140, which can include program instructions executable using a processor 132. These features are shown herein in FIG. 1, and also in an embodiment of a computer system shown in FIG. 10 referring to one or more computer systems 1010, which may include one or more generic computer components.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Specifically, regarding the control system 170, a device(s) 130, or in one example devices which can belong to one or more users, can be in communication with the control system 170 via the communications network 160. In the embodiment of the control system shown in FIG. 1, the control system 170 includes a computer 172 communicating with a database 176 and one or more programs 174 stored on a computer readable storage medium 173. In the embodiment of the disclosure shown in FIG. 1, the device 130 communicates with the control system 170 and the one or more programs 174 stored on a computer readable storage medium 173. The control system includes the computer 172 having a processor 175, which also has access to the database 176.

The control system 170 can include a storage medium 180 for maintaining a registration 182 of users and their devices for analysis of the audio input. Such registration can include user profiles 183, which can include user data supplied by the users in reference to registering and setting-up an account. In an embodiment, the method and system which incorporates the present disclosure includes the control system (generally referred to as the back-end) in combination and cooperation with a front end of the method and system, which can be the application 140. In one example, the application 140 is stored on a device, for example, a computer or device on location 130, and can access data and additional programs at a back end of the application, e.g., control system 170.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of a device and computer 130 having the application 140. The application 140 is stored on the device or computer 130 and can access data and additional programs at the back end of the application, for example, in the program(s) 174 stored in the control system 170.

The program(s) 174 can include, all or in part, a series of executable steps for implementing the method of the present disclosure. A program, incorporating the present method, can be all or in part stored in the computer readable storage medium on the control system or, in all or in part, on a computer or device 130. It is envisioned that the control system 170 can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 183, however, the method can include multiple profiles, users, registrations, etc. It is envisioned that a plurality of users or a group of users can register and provide profiles using the control system for use according to the method and system of the present disclosure.

### Still Further Embodiments and Examples

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more FIGS. may be similar to operational blocks another FIG. A method shown in one FIG. may be another example embodiment which can include aspects/operations shown in another FIG. and discussed previously.

### Additional Embodiments and Examples

Account data, for instance, including profile data related to a user, and any data, personal or otherwise, can be collected and stored, for example, in the control system 170. It is understood that such data collection is done with the knowledge and consent of a user, and stored to preserve privacy, which is discussed in more detail below. Such data can include personal data, and data regarding personal items.

In one example a user can register 182 have an account 181 with a user profile 183 on a control system 170, which is discussed in more detail below. For example, data can be collected using techniques as discussed above, for example, using cameras, and data can be uploaded to a user profile by the user.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for a learning model for facilitating web page selection for a user navigating multiple web pages.

In another example, the control system 70 can be all or part of an Artificial Intelligence (AI) system. For example, the control system can be one or more components of an AI system.

It is also understood that the method 100 according to an embodiment of the present disclosure, can be incorporated into (Artificial Intelligence) AI devices, which can communicate with respective AI systems, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

Referring to FIG. 10, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 170, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Aspects and Examples

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

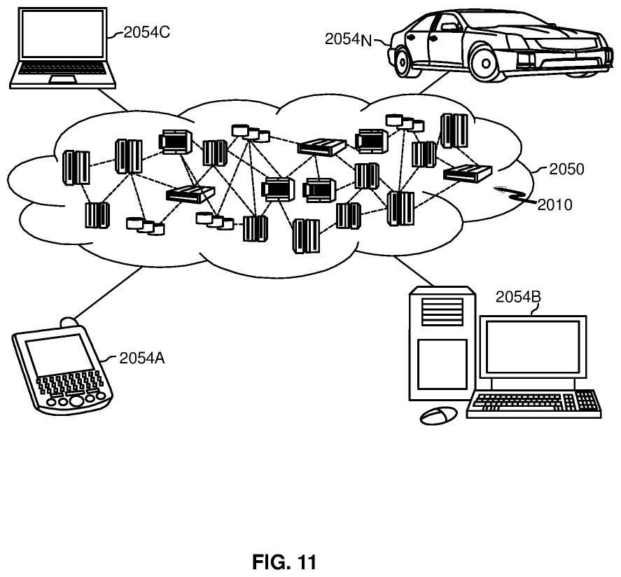

Referring now to FIG. 11, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 11 are intended to be illustrative only and that computing nodes 2010 and cloud computing environment 2050 can communicate with any type of computerized device over any type of network and/or network addressable connection (e.g., using a web browser).

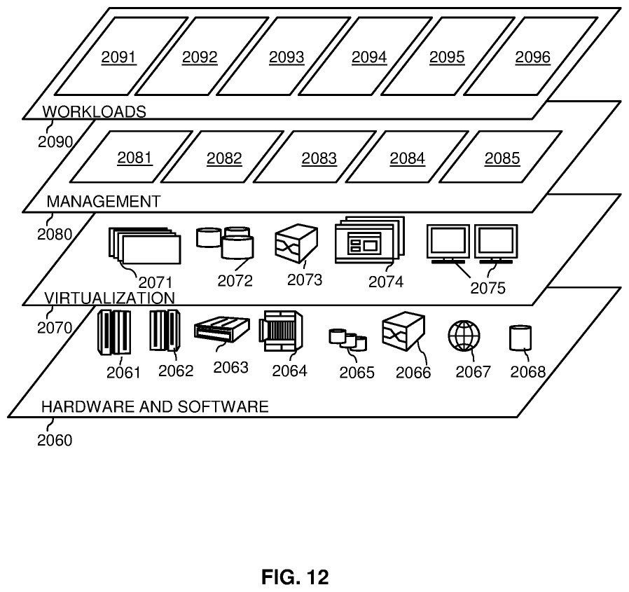

Referring now to FIG. 12, a set of functional abstraction layers provided by cloud computing environment 2050 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below.

Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and computer automated assistance for organizing data 2096, for example, for facilitating web page selection by a user navigating multiple web pages.

What is claimed is:

1. A computer-implemented method for facilitating web page selection for a user navigating multiple web pages, comprising:
determining, using a computer, a probability of each of a plurality of web pages being visited by a user, the web pages being opened by the user using a device, the probability being determined using machine learning and user operational behavior analysis based on an analysis of the web page features for each of the web pages being visited by the user and filtering the web pages by classifying the web page features;
ordering, using a cognitive analysis, the open web pages in an order based on the probability of each of the web pages being visited by the user, the order ranking the plurality of web pages based on a highest probability of a web page of the plurality of web pages being visited; and
managing the open web pages based on the ordering of the open web pages, the managing including prompting the user to visit a web page of the open web pages in response to the ranking of an open web page in the order.

2. The method of claim 1, further comprising:
analyzing, using a computer, web page features of respective web pages opened by a user using a device;
filtering the web pages by classifying the web page features using a matrix of classification for each of the features; and
generating a filtered web page collection based on the classifying of the web page features.

3. The method of claim 1, wherein the managing includes prompting the user to visit a web page of the open web pages having the highest probability of being visited by the user.

4. The method of claim 1, wherein the page features include multiple attributes relating to each of the open web pages.

5. The method of claim 1, wherein the page features include multiple attributes relating to each of the open web pages; and
analyzing the page features wherein the analyzing includes classifying the features and attributes into patterns.

6. The method of claim 1, wherein the page features include multiple attributes relating to each of the open web pages; and
analyzing the page features wherein the analyzing includes classifying the features and attributes into patterns, wherein the patterns include a continuation regular pattern and a non-continuation pattern.

7. The method of claim 1, wherein the page features include opening time of the page and a source of the page.

8. The method of claim 1, wherein as part of the determining of the probability of each of the web pages being visited by the user, the determining includes logic for switching pages; and
training a learning module to learn the logic.

9. The method of claim 1, further comprising:
determining a page jump operation using the cognitive analysis, the cognitive analysis includes quantitative analysis of a visit possibility for the filtered page collection; and
providing page jump information for the managing of the open web pages.

10. A system using a computer for facilitating web page selection for a user navigating multiple web pages, which comprises:
a computer system comprising; a computer processor, a computer-readable storage medium, and program instructions stored on the computer-readable storage medium being executable by the processor, to cause the computer system to perform the following functions to;
determine, using a computer, a probability of each of a plurality of web pages being visited by a user, the web pages being opened by the user using a device, the probability being determined using machine learning and user operational behavior analysis based on an analysis of the web page features for each of the web pages being visited by the user and filtering the web pages by classifying the web page features;
order, using a cognitive analysis, the open web pages in an order based on the probability of each of the web pages being visited by the user, the order ranking the plurality of web pages based on a highest probability of a web page of the plurality of web pages being visited; and
manage the open web pages based on the ordering of the open web pages, the managing including prompting the user to visit a web page of the open web pages in response to the ranking of an open web page in the order.

11. The system of claim 10, further comprising:
analyzing, using a computer, web page features of respective web pages opened by a user using a device;
filtering the web pages by classifying the web page features using a matrix of classification for each of the features; and
generating a filtered web page collection based on the classifying of the web page features.

12. The system of claim 10, wherein the managing includes prompting the user to visit a web page of the open web pages having the highest probability of being visited by the user.

13. The system of claim 10, wherein the page features include multiple attributes relating to each of the open web pages.

14. The system of claim 10, wherein the page features include multiple attributes relating to each of the open web pages; and
analyzing the page features wherein the analyzing includes classifying the features and attributes into patterns.

15. The system of claim 10, wherein the page features include multiple attributes relating to each of the open web pages; and
analyzing the page features wherein the analyzing includes classifying the features and attributes into patterns, wherein the patterns include a continuation regular pattern and a non-continuation pattern.

16. The system of claim 10, wherein the page features include opening time of the page and a source of the page.

17. The system of claim 10, wherein as part of the determining of the probability of each of the web pages being visited by the user includes logic for switching pages; and
training a learning module to learn the logic.

18. The system of claim 10, further comprising:
determining a page jump operation using the cognitive analysis, the cognitive analysis includes quantitative analysis of a visit possibility for the filtered page collection; and
providing page jump information for the managing of the open web pages.

19. A computer program product for facilitating web page selection for a user navigating multiple web pages, the computer program product comprising a computer readable storage medium having program instructions embodied therewith, the program instructions executable by a computer to cause the computer to perform functions, by the computer, comprising the functions to:
determine, using a computer, a probability of each of a plurality of web pages being visited by a user, the web pages being opened by the user using a device, the probability being determined using machine learning and user operational behavior analysis based on an analysis of the web page features for each of the web pages being visited by the user and filtering the web pages by classifying the web page features;
order, using a cognitive analysis, the open web pages in an order based on the probability of each of the web pages being visited by the user, the order ranking the plurality of web pages based on a highest probability of a web page of the plurality of web pages being visited; and
manage the open web pages based on the ordering of the open web pages, the managing including prompting the user to visit a web page of the open web pages in response to the ranking of an open web page in the order.

20. The computer program product of claim 19, further comprising:
analyzing, using a computer, web page features of respective web pages opened by a user using a device;
filtering the web pages by classifying the web page features using a matrix of classification for each of the features; and
generating a filtered web page collection based on the classifying of the web page features.
